(19) United States
(12) Patent Application Publication
(10) Pub. No.: US 2024/0343869 A1
(43) Pub. Date: Oct. 17, 2024

(54) EPOXY RESIN LAMINATE REINFORCED BY MEANS OF CARBON-BASALT HYBRID FIBERS AND MANUFACTURING METHOD THEREFOR

(71) Applicant: Beijing Institute of Technology, Beijing (CN)

(72) Inventor: Weifu SUN, Beijing (CN)

(73) Assignee: Beijing Institute of Technology, Beijing (CN)

(21) Appl. No.: 18/391,698

(22) Filed: Dec. 21, 2023

(30) Foreign Application Priority Data
Apr. 12, 2023 (CN) 202310385505.3

(51) Int. Cl. C08J 5/04

(52) U.S. Cl. CPC C08J 5/0405; C08J 5/042; C08J 2363/00

(57) ABSTRACT

An epoxy resin laminate reinforced by carbon-basalt hybrid fibers and a manufacturing method therefor are provided. The manufacturing method includes: brushing an epoxy resin mixture by using a manual laying method, and laying carbon fiber felts and basalt fiber felts according to components and superposing modes to obtain superposed fiber felts after laying; placing the superposed fiber felts after laying into a vacuum bag, and evacuating air; and placing the superposed fiber felts after laying in a vulcanizing machine, heating the superposed fiber felts to a temperature required for a crosslinking reaction between epoxy resin and a curing agent by using a preset heating method, applying pressure by an upper die and a lower die to ensure that interiors of the superposed fiber felts are compact and surfaces are smooth, and keeping the temperature and the pressure to obtain the epoxy resin laminate reinforced by the carbon-basalt hybrid fibers.

### CROSS REFERENCE TO THE RELATED APPLICATIONS

This application is based upon and claims priority to Chinese Patent Application No. 202310385505.3, filed on Apr. 12, 2023, the entire contents of which are incorporated herein by reference.

### TECHNICAL FIELD

The present invention relates to the technical field of composites, and in particular to an epoxy resin laminate reinforced by means of carbon-basalt hybrid fibers and a manufacturing method therefor.

### BACKGROUND

Fiber reinforced composites, especially carbon fiber reinforced plastic (CFRP) composites, have been widely used in aerospace, automotive and civil industries due to the excellent specific strength, specific stiffness, fatigue resistance and corrosion resistance thereof. However, brittleness of the carbon fiber (CF) seriously reduces reliability of the CFRP composites under an impact load, which limits application of the CFRP composites. Properties of the fiber reinforced composites depend largely on fiber types, resin systems and lay-up methods and other factors. A large number of studies show that fiber hybridization can effectively overcome defects of the CFRP composites. Glass fibers or nylon fibers are used as hybrid components with the CFRP composites to improve toughness and reduce manufacturing prices of the CFRP composites. However, these fibers have adverse effects on human health and an environment during manufacturing, and have poor resistance to acidic and alkaline environments.

The basalt fiber (BF) has received wide attention due to excellent mechanical properties, thermal stability, and chemical stability thereof. As a natural inorganic fiber, the BF is considered as a potential substitute for glass fibers because of a simple production process, environmental protection and low cost thereof. More importantly, interface properties between the BF and epoxy resin (EP) are better than those between the glass fibers and EP. Many studies show that superposing BF layers can effectively improve tensile properties, bending properties and low speed impact resistance of the CFRP composites. However, the impact resistance and failure mechanism of BF/CF/EP composites under a high speed impact are seldom studied. Furthermore, influence of fiber superposition on energy absorption, penetration behavior and failure modes of the BF/CF/EP composites is not clear. In view of significant practical requirements of aerospace, automobile, energy and other industries for carbon fiber reinforced epoxy resin composites, and the problems existing in methods for improving impact resistance at the present stage, the present invention provides an epoxy resin laminate reinforced by means of carbon-basalt hybrid fibers and a manufacturing method therefor, and the energy absorption characteristics of the fiber reinforced epoxy resin composites are remarkably improved by changing components and superposing modes of various fibers.

### SUMMARY

Based on this, it is necessary to provide an epoxy resin laminate reinforced by means of carbon-basalt hybrid fibers and a manufacturing method therefor.

A manufacturing method for an epoxy resin laminate reinforced by means of carbon-basalt hybrid fibers includes the following steps: brushing an epoxy resin mixture by using a manual laying method, and laying carbon fiber felts and basalt fiber felts according to components and superposing modes to obtain superposed fiber felts after laying; placing the superposed fiber felts after laying into a vacuum bag, and evacuating air; and placing the superposed fiber felts after laying in a vulcanizing machine, heating the superposed fiber felts to a temperature required for a crosslinking reaction between epoxy resin and a curing agent by using a preset heating method, applying pressure by means of an upper die and a lower die to ensure that interiors of the superposed fiber felts are compact and surfaces are smooth, and keeping the temperature and the pressure to obtain the epoxy resin laminate reinforced by means of carbon-basalt hybrid fibers.

Preferably, before the using the manual laying method, the method further includes: cutting the carbon fiber felts and the basalt fiber felts into sizes suitable for a space of a hot press.

Preferably, a preparation process of the epoxy resin mixture specifically includes: heating the epoxy resin and the curing agent to a liquid state at 75° C. and 100° C. respectively, then mixing same at a mass ratio of 100:26.7, and performing electromagnetic stirring under a heating condition of 75° C. to uniformly mix the mixture to obtain the epoxy resin mixture, where the epoxy resin is E51 type epoxy resin, and the curing agent is a malonaldehyde (MDA) type curing agent.

Preferably, the brushing an epoxy resin mixture specifically includes: brushing the epoxy resin mixture over both sides of the carbon fiber felts and basalt fiber felts by using a brush, such that the carbon fiber felts and the basalt fiber felts are impregnated with the epoxy resin.

Preferably, the laying carbon fiber felts and basalt fiber felts according to components and superposing modes to obtain superposed fiber felts after laying specifically includes: manually laying 16 layers of superposed fiber felts by changing components and superposing modes of the carbon fiber felts and the basalt fiber felts to obtain the superposed fiber felts after laying.

The components of the carbon fiber felts and basalt fiber felts are specifically as follows:

(1) Only the carbon fiber felts are used, and 16 layers of superposed fiber felts are laid.

(2) A layer number ratio of the carbon fiber felts to the basalt fiber felts is 3:1, the method of laying 1 layer of basalt fiber felt first and then laying 3 layers of carbon fiber felts upwards is used, and cycle laying is performed according to the layer number ratio of 3:1 until 16 layers of superposed fiber felts are laid.

(3) A layer number ratio of the carbon fiber felts to the basalt fiber felts is 1:1, the method of laying 1 layer of basalt fiber felt first and then laying 1 layer of carbon fiber felt upwards is used, and cycle laying is performed according to the layer number ratio of 1:1 until 16 layers of superposed fiber felts are laid.

(4) A layer number ratio of the carbon fiber felts to the basalt fiber felts is 1:3, the method of laying 3 layers of basalt fiber felts first and then laying 1 layer of carbon fiber felt upwards is used, and cycle laying is performed according to the layer number ratio of 1:3 until 16 layers of superposed fiber felts are laid.

(5) Only the basalt fiber felts are used, and 16 layers of superposed fiber felts are laid.

The superposing modes of the carbon fiber felts and the basalt fiber felts specifically include:

(1) The method of laying 8 layers of basalt fiber felts first and then laying 8 layers of carbon fiber felts upwards is used for laying 16 layers of superposed fiber felts.

(2) The method of laying 8 layers of carbon fiber felts first and then laying 8 layers of basalt fiber felts upwards is used for laying 16 layers of superposed fiber felts.

(3) The method of laying 4 layers of carbon fiber felts first, then laying 8 layers of basalt fiber felts upwards, and finally laying 4 layers of carbon fiber felts upwards is used for laying 16 layers of superposed fiber felts.

(4) The method of laying 4 layers of basalt fiber felts first, then laying 8 layers of carbon fiber felts upwards, and finally, laying 4 layers of basalt fiber felts upwards is used for laying 16 layers of superposed fiber felts.

(5) The method of laying 1 layer of basalt fiber felt first and then laying 1 layer of carbon fiber felt upwards is used, and cycle laying is performed according to the layer number ratio of the carbon fiber felts to the basalt fiber felts of 1:1 until 16 layers of superposed fiber felts are laid.

(6) The method of laying 1 layer of carbon fiber felt and then laying 1 layer of basalt fiber felt upwards is used, and cycle laying is performed according to the layer number ratio of the carbon fiber felts to the basalt fiber felts of 1:1 until 16 layers of superposed fiber felts are laid.

Preferably, the placing the superposed fiber felts after laying into a vacuum bag, and evacuating air specifically include: placing the carbon/basalt hybrid fibers after laying in a vacuum bag, laying a polytetrafluoroethylene film between the superposed fiber felts and the vacuum bag for demolding the laminate from the vacuum bag after hot pressing, and evacuating air from the vacuum bag at a temperature of 70° C. for degassing, such that the superposed fiber felts are completely impregnated with the epoxy resin mixture.

Preferably, the placing the superposed fiber felts after laying in a vulcanizing machine, heating the superposed fiber felts to a temperature required for a crosslinking reaction between epoxy resin and a curing agent by using a preset heating method, applying pressure by means of an upper die and a lower die to ensure that interiors of the superposed fiber felts are compact and surfaces are smooth, and keeping the temperature and the pressure to obtain the epoxy resin laminate reinforced by means of carbon-basalt hybrid fibers specifically include: placing the superposed fiber felts impregnated with the epoxy resin mixture between heating die plates of a vulcanizing machine, placing a supporting die with a thickness of 3.6 mm between an upper die and a lower die of the vulcanizing machine, and applying pressure by means of the upper die and the lower die, such that interiors of the superposed fiber felts are compact, surfaces are smooth, and the superposed fiber felts have the same thickness of 3.6 mm; and performing hot pressing for 17 h at a preset heating temperature of 120° C., a constant temperature and a constant pressure, and then performing curing for 2 h after the temperature is 180° C. to obtain the epoxy resin laminate reinforced by means of carbon-basalt hybrid fibers.

Preferably, after the step of obtaining the epoxy resin laminate reinforced by means of carbon-basalt hybrid fibers, the method further includes: cutting the epoxy resin laminate into a standard size of 105×105 mm² by using a high speed rotating serrated disc.

As a general technical concept, the present invention further provides an epoxy resin laminate reinforced by means of carbon-basalt hybrid fibers which is manufactured by using the above manufacturing method.

The present invention has the advantages and beneficial effects as follows: according to the present invention, energy absorption characteristics of fiber reinforced epoxy resin composites can be obviously improved by changing the components and the superposing mode of various fibers. For samples obtained by changing the components of various fibers, an energy absorption rate, a delamination area, an out-of-plane deformation area and the maximum out-of-plane displacement of a carbon fiber (CF)/basalt fiber (BF)/epoxy resin (EP) laminate all show an increasing trend along with an increase of a BF content, and the optimized BF component can make the energy absorption property of the CF/BF/EP laminate in an impact speed range of 191.64-206.38 m/s be better than that of a pure CF laminate. For samples obtained by changing the superposing mode, the superposing mode changes a failure mechanism of the CF/BF/EP laminate so as to significantly improves the energy absorption characteristic of the CF/BF/EP laminate.

### BRIEF DESCRIPTION OF THE DRAWINGS

FIG. 1 is a flowchart of a manufacturing method for an epoxy resin laminate reinforced by means of carbon-basalt hybrid fibers in an example of the present invention;

FIGS. 2A-2B show schematic diagrams for a superposing manner of 16 layers of superposed fiber felts in an example of the present invention, where FIG. 2A shows a superposing manner of samples of different components, and FIG. 2B shows a superposing manner of samples in different superposing modes;

FIG. 3 is a schematic diagram for hot pressing of superposed fiber felts in an example of the present invention;

FIGS. 4A-4D are schematic diagrams of a ballistic impact experimental system in an example of the present invention;

FIGS. 5A-5C are schematic diagrams of an ultrasonic C-scan nondestructive testing system in an example of the present invention;

FIGS. 6A-6D show column contrast diagrams of various parameters of samples with different components in an impact speed range of 191.64-206.38 m/s in an example of the present invention, where FIG. 6A is a column contrast diagram of an energy absorption rate, FIG. 6B is a column contrast diagram of a delamination area, FIG. 6C is a column contrast diagram of an out-of-plane deformation area, and FIG. 6D is a column contrast diagram of the maximum out-of-plane displacement; and

FIGS. 7A-7D show column contrast diagrams of various parameters of samples in different superposing modes in an impact speed range of 198.32-205.56 m/s in an example of the present invention, where FIG. 7A is a column contrast diagram of an energy absorption rate, FIG. 7B is a column contrast diagram of a delamination area, FIG. 7C is a column contrast diagram of an out-of-plane deformation area, and FIG. 7D is a column contrast diagram of the maximum out-of-plane displacement.

### DETAILED DESCRIPTION OF THE EMBODIMENTS

To make objectives, technical solutions and advantages of the invention clearer, the present invention will be further described in detail through particular embodiments with reference to the accompanying drawings. It should be understood that the particular examples described herein are merely used for explaining the present invention, and are not used for limiting the present invention.

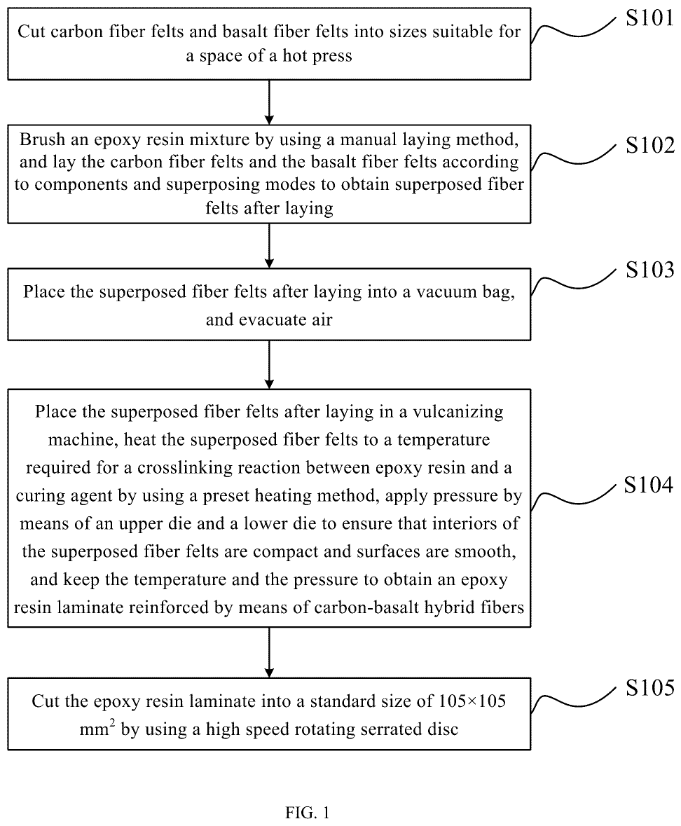

As shown in FIG. 1, the present invention provides a manufacturing method for an epoxy resin laminate reinforced by means of carbon-basalt hybrid, and the method includes the following steps:

Step S101, cut carbon fiber felts and basalt fiber felts into sizes suitable for a space of a hot press.

Step S102, brush an epoxy resin mixture by using a manual laying method, and lay the carbon fiber felts and the basalt fiber felts according to components and superposing modes to obtain superposed fiber felts after laying.

A preparation process of the epoxy resin mixture specifically includes: heat the epoxy resin and the curing agent to a liquid state at 75° C. and 100° C. respectively, then mix same at a mass ratio of 100:26.7, and perform electromagnetic stirring under a heating condition of 75° C. to uniformly mix the mixture to obtain the epoxy resin mixture, where the epoxy resin is E51 type epoxy resin, and the curing agent is an MDA type curing agent.

The step of brushing an epoxy resin mixture specifically includes: brush the epoxy resin mixture over both sides of the carbon fiber felts and basalt fiber felts by using a brush, such that the carbon fiber felts and the basalt fiber felts are impregnated with the epoxy resin.

The step of laying the carbon fiber felts and the basalt fiber felts according to components and superposing modes to obtain superposed fiber felts after laying specifically includes: manually lay 16 layers of superposed fiber felts by changing components and superposing modes of the carbon fiber felts and the basalt fiber felts to obtain the superposed fiber felts after laying.

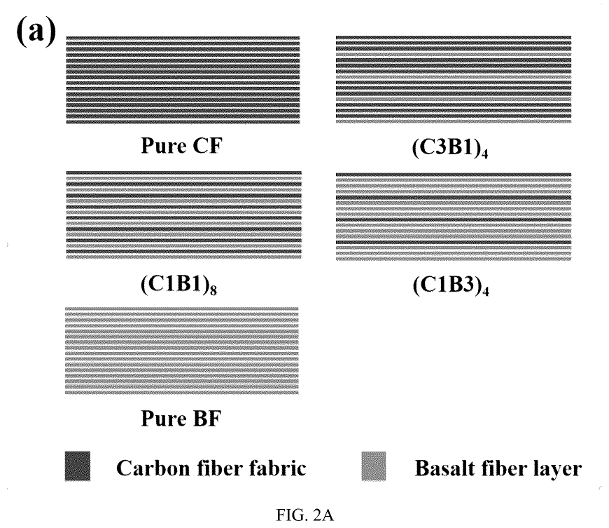

As shown in FIG. 2A and Table 1, the components of the carbon fiber felts and basalt fiber felts designed in the present invention are specifically as follows:

(1) Only the carbon fiber felts are used, and 16 layers of superposed fiber felts are laid.

(2) A layer number ratio of the carbon fiber felts to the basalt fiber felts is 3:1, the method of laying 1 layer of basalt fiber felt first and then laying 3 layers of carbon fiber felts upwards is used, and cycle laying is performed according to the layer number ratio of 3:1 until 16 layers of superposed fiber felts are laid.

(3) A layer number ratio of the carbon fiber felts to the basalt fiber felts is 1:1, the method of laying 1 layer of basalt fiber felt first and then laying 1 layer of carbon fiber felt upwards is used, and cycle laying is performed according to the layer number ratio of 1:1 until 16 layers of superposed fiber felts are laid.

(4) A layer number ratio of the carbon fiber felts to the basalt fiber felts is 1:3, the method of laying 3 layers of basalt fiber felts first and then laying 1 layer of carbon fiber felt upwards is used, and cycle laying is performed according to the layer number ratio of 1:3 until 16 layers of superposed fiber felts are laid.

(5) Only the basalt fiber felts are used, and 16 layers of superposed fiber felts are laid.

As shown in FIGS. 2A-2B and Table 1, the superposing modes of the carbon fiber felts and the basalt fiber felts specifically include:

(1) The method of laying 8 layers of basalt fiber felts first and then laying 8 layers of carbon fiber felts upwards is used for laying 16 layers of superposed fiber felts.

(2) The method of laying 8 layers of carbon fiber felts first and then laying 8 layers of basalt fiber felts upwards is used for laying 16 layers of superposed fiber felts.

(3) The method of laying 4 layers of carbon fiber felts first, then laying 8 layers of basalt fiber felts upwards, and finally laying 4 layers of carbon fiber felts upwards is used for laying 16 layers of superposed fiber felts.

(4) The method of laying 4 layers of basalt fiber felts first, then laying 8 layers of carbon fiber felts upwards, and finally, laying 4 layers of basalt fiber felts upwards is used for laying 16 layers of superposed fiber felts.

(5) The method of laying 1 layer of basalt fiber felt first and then laying 1 layer of carbon fiber felt upwards is used, and cycle laying is performed according to the layer number ratio of the carbon fiber felts to the basalt fiber felts of 1:1 until 16 layers of superposed fiber felts are laid.

(6) The method of laying 1 layer of carbon fiber felt and then laying 1 layer of basalt fiber felt upwards is used, and cycle laying is performed according to the layer number ratio of the carbon fiber felts to the basalt fiber felts of 1:1 until 16 layers of superposed fiber felts are laid.

In the present invention, sample type information represented in Table 1 is used, where the sample with BF as the back is defined as type A, and the sample with CF as the back is defined as type B.

TABLE 1
Sample type information

| | The layer | Total layer | | | |
|---|---|---|---|---|---|
| Configura- | number ratio of | number of | Impact | Back | Specimen |
| tion | CF and BF | fiber fabric | surface | surface | type |
| Pure CF | — | 16 | CF | BF | B |
| (C3B1)₄ | 3:1 | 16 | CF | BF | A |
| (C1B1)₈ | 1:1 | 16 | CF | BF | A |
| (C1B3)₄ | 1:3 | 16 | CF | BF | A |
| Pure BF | — | 16 | BF | BF | A |
| C8B8 | 1:1 | 16 | CF | BF | A |
| B8C8 | 1:1 | 16 | BF | CF | B |
| C4B8C4 | 1:1 | 16 | CF | CF | B |
| B4C8B4 | 1:1 | 16 | BF | BF | A |
| (B1C1)₈ | 1:1 | 16 | BF | CF | B |

Step S103, place the superposed fiber felts after laying into a vacuum bag, and evacuate air.

The steps of placing the superposed fiber felts after laying into a vacuum bag, and evacuating air specifically include: place the carbon/basalt hybrid fibers after laying in a vacuum bag, lay a polytetrafluoroethylene film between the superposed fiber felts and the vacuum bag for demolding the laminate from the vacuum bag after hot pressing, and evacuate air from the vacuum bag at a temperature of 70° C. for degassing, such that the superposed fiber felts are completely impregnated with the epoxy resin mixture.

Step S104, place the superposed fiber felts after laying in a vulcanizing machine, heat the superposed fiber felts to a temperature required for a crosslinking reaction between the epoxy resin and the curing agent by using a preset heating method, apply pressure by means of an upper die and a lower die to ensure that interiors of the superposed fiber felts are compact and surfaces are smooth, and keep the temperature and the pressure to obtain the epoxy resin laminate reinforced by means of carbon-basalt hybrid fibers.

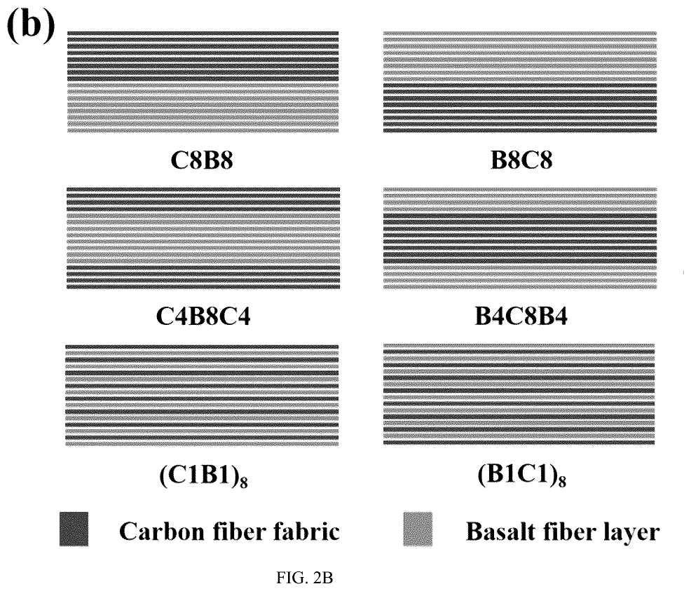

The steps of placing the superposed fiber felts after laying in a vulcanizing machine, heating the superposed fiber felts to a temperature required for a crosslinking reaction between the epoxy resin and the curing agent by using a preset heating method, applying pressure by means of an upper die and a lower die to ensure that interiors of the superposed fiber felts are compact and surfaces are smooth, and keeping the temperature and the pressure to obtain the epoxy resin laminate reinforced by means of carbon-basalt hybrid fibers specifically include: place the superposed fiber felts impregnated with the epoxy resin mixture between heating die plates of a vulcanizing machine, as shown in FIG. 3, place a supporting die with a thickness of 3.6 mm between an upper die and a lower die of the vulcanizing machine, and apply pressure by means of the upper die and the lower die, such that interiors of the superposed fiber felts are compact, surfaces are smooth, and the superposed fiber felts have the same thickness of 3.6 mm; and perform hot pressing for 17 h at a preset heating temperature of 120° C., a constant temperature and a constant pressure, and then perform curing for 2 h after the temperature is 180° C. to obtain the epoxy resin laminate reinforced by means of carbon-basalt hybrid fibers.

Step S105, cut the epoxy resin laminate into a standard size of 105×105 mm² by using a high speed rotating serrated disc.

Based on the above manufacturing method, the present invention further provides an epoxy resin laminate reinforced by means of carbon-basalt hybrid fibers. A reinforced epoxy resin laminate.

The present invention is further described below in conjunction with the accompanying drawings and particular preferred examples, but the protection scope of the present invention is not limited herein.

### Example 1

CF/BF/EP laminates of different BF components were manufactured in this example, where carbon fibers and basalt fibers were commercially available plain fiber felts, epoxy resin was E51 epoxy resin and a curing agent was MDA curing agent, both of which were commercially available.

A manufacturing method for the CF/BF/EP laminates with different BF components includes the following steps:

Step 1, the carbon fiber felts and the basalt fiber felts were cut into sizes suitable for a space of a hot press, and a mixture of the epoxy resin and the curing agent was obtained by means of electromagnetic stirring.

Step 2, the epoxy resin mixture was brushed over both sides of the carbon fiber felts and basalt fiber felts by using a brush, such that the fiber felts were impregnated with the epoxy resin. 16 layers of superposed fiber felts were manually laid by changing a layer number ratio of the carbon fiber felts to the basalt fiber felts to obtain superposed fiber felts of different components as shown in FIG. 2A.

Step 3, the carbon/basalt hybrid fibers after laying were placed in a vacuum bag, and a polytetrafluoroethylene film was laid between the superposed fiber felts and the vacuum bag for demolding the laminate from the vacuum bag after hot pressing.

Step 4, air was evacuated from the vacuum bag at a temperature of 70° C. for degassing, such that the superposed fiber felts were completely impregnated with the epoxy resin.

Step 5, the superposed fiber felts impregnated with the epoxy resin were placed between heating die plates of a vulcanizing machine, a supporting die with a thickness of 3.6 mm was placed between an upper die and a lower die of the vulcanizing machine, and pressure was applied by means of the upper die and the lower die, such that interiors of the superposed fiber felts were compact, surfaces were smooth, and the superposed fiber felts had the same thickness of 3.6 mm as shown in FIG. 3. Hot pressing was performed for 17 h at a preset heating temperature of 120° C., a constant temperature and a constant pressure, and then curing was performed for 2 h after the temperature was 180° C. to obtain the epoxy resin laminate reinforced by means of carbon-basalt hybrid fibers.

Step 6, the epoxy resin laminate was cut into a standard size of 105×105 mm² by using a high speed rotating serrated disc.

### Example 2

CF/BF/EP laminates in different superposing modes were manufactured in this example, where carbon fibers and basalt fibers were commercially available plain fiber felts, epoxy resin was E51 epoxy resin and a curing agent was MDA curing agent, both of which were commercially available.

A manufacturing method for the CF/BF/EP laminates in different superposing modes includes the following steps:

Step 1, the carbon fiber felts and the basalt fiber felts were cut into sizes suitable for a space of a hot press, and a mixture of the epoxy resin and the curing agent was obtained by means of electromagnetic stirring.

Step 2, the epoxy resin mixture was brushed over both sides of the carbon fiber felts and basalt fiber felts by using a brush, such that the fiber felts were impregnated with the epoxy resin. 16 layers of superposed fiber felts were manually laid by changing a layer number ratio of the carbon fiber felts to the basalt fiber felts to obtain superposed fiber felts in different superposing modes as shown in FIG. 2B.

Step 3, the carbon/basalt hybrid fibers after laying were placed in a vacuum bag, and a polytetrafluoroethylene film was laid between the superposed fiber felts and the vacuum bag for demolding the laminate from the vacuum bag after hot pressing.

Step 4, air was evacuated from the vacuum bag at a temperature of 70° C. for degassing, such that the superposed fiber felts were completely impregnated with the epoxy resin.

Step 5, the superposed fiber felts impregnated with the epoxy resin were placed between heating die plates of a vulcanizing machine, a supporting die with a thickness of 3.6 mm was placed between an upper die and a lower die of the vulcanizing machine, and pressure was applied by means of the upper die and the lower die, such that interiors of the superposed fiber felts were compact, surfaces were smooth, and the superposed fiber felts had the same thickness of 3.6 mm as shown in FIG. 3. Hot pressing was performed for 17 h at a preset heating temperature of 120° C., a constant temperature and a constant pressure, and then curing was performed for 2 h after the temperature was 180° C. to obtain the epoxy resin laminate reinforced by means of carbon-basalt hybrid fibers.

Step 6, the epoxy resin laminate was cut into a standard size of 105×105 mm² by using a high speed rotating serrated disc.

### Energy Absorption Characteristic Testing

In the present invention, a ballistic impact experiment was used for testing energy absorption characteristics of the epoxy resin laminates manufactured in Examples 1 and 2, and an ultrasonic C-scan device was used for testing damage modes of the epoxy resin laminates manufactured in Examples 1 and 2.

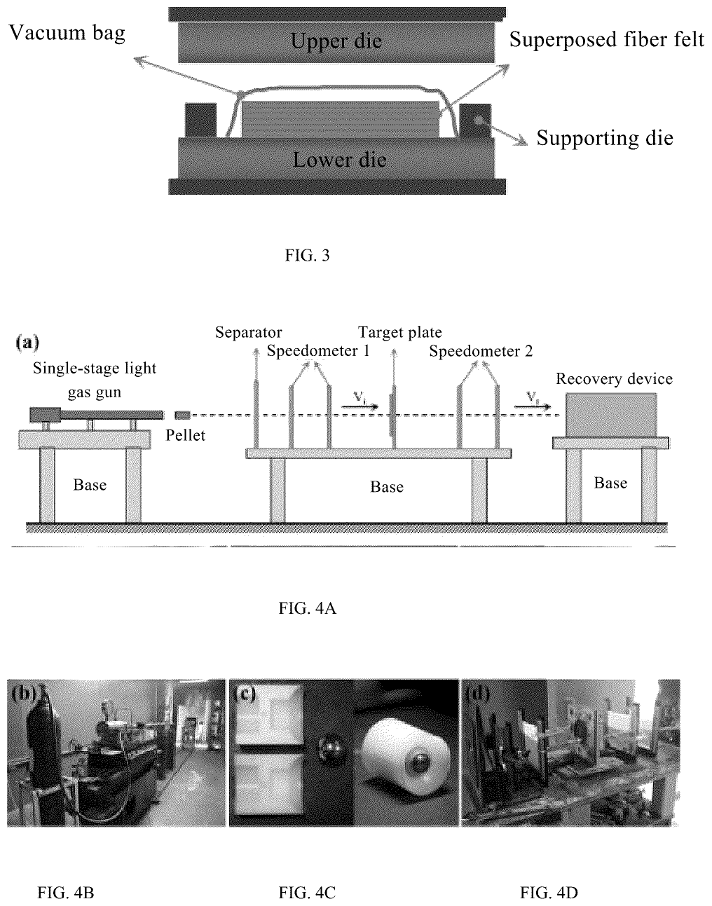

FIGS. 4A-4D show schematic diagrams of a ballistic impact experimental system. The ballistic impact experimental system is mainly composed of a single-stage gas gun with a caliber of 25 mm, pellets, a separator, two speedometers, a target plate and a pellet recovery device, where the pellets are of steel balls with a density of 7.85 g/cm³ and a diameter of 13 mm. During flight, due to air resistance, a pellet carrier is separated from the pellet and is blocked by the separator. A hole is reserved in a center of the separator, such that the pellet can pass through the hole and shoot to the target plate. In order to measure a speed of the pellet before and after an impact, two speedometers are placed in front of and behind the target plate respectively, where speedometer 1 is used for measuring an initial speed Vᵢ of the pellet, and speedometer 2 is used for measuring a residual speed Vᵣ of the pellet.

Moreover, an energy absorption ratio R can be calculated from the following formula:

$$\begin{matrix}{E}_{a b s} = \frac{1}{2} m {V}_{i}^{2} - \frac{1}{2} m {V}_{r}^{2} \\ EAR = \frac{{E}_{a b s}}{{E}_{i}}\end{matrix}$$

In the formula, where E_{abs} represents energy absorbed by the FRP laminate, Vᵢ and Vᵣ represent the initial speed and residual speed of the pellet respectively, m represents a mass of the pellet, and Eᵢ represents initial kinetic energy of the pellet.

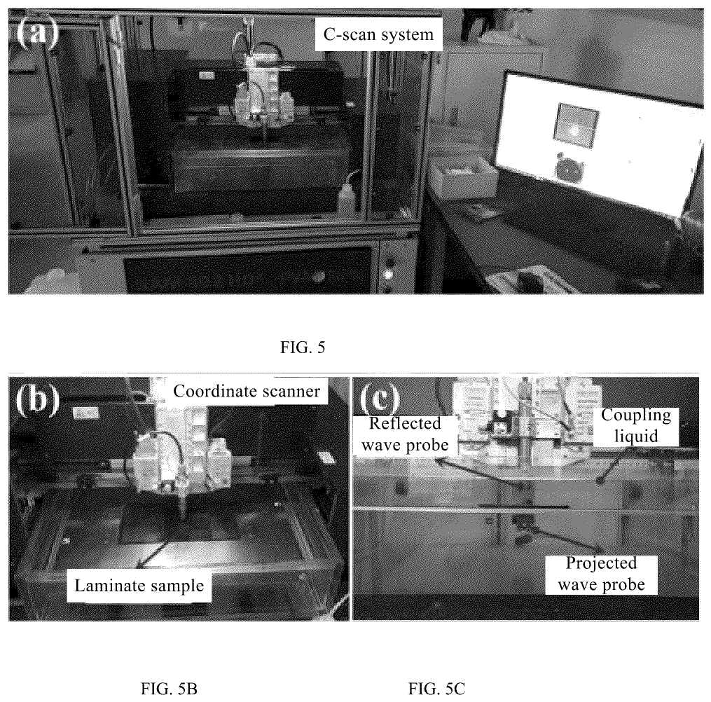

FIGS. 5A-5C show schematic diagrams for composition of an ultrasonic C-scan system. A C-scan scanning device takes a coupling liquid as a medium, and characterizes internal damage and external deformation of composites by means of high-frequency transmitted sound waves and reflected sound waves respectively. Test results are visualized and quantified by means of analysis software of the testing system. An ultrasonic frequency of 35 Hz is used, a focal length of a probe is 30 mm, a scanning step is set to 100 μm, and all the samples are measured under the same conditions.

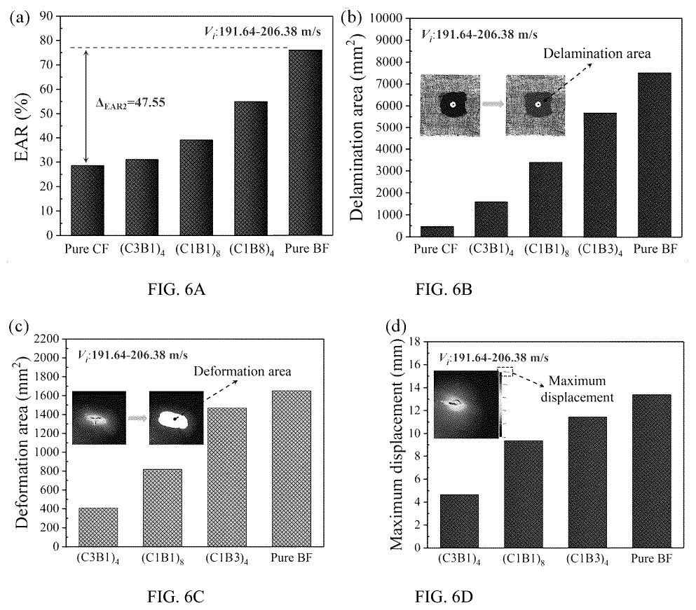

FIGS. 6A-6D show energy absorption characteristics of FRP composites with different BF components (i.e. Example 1). Results show that an energy absorption rate, a delamination area, an out-of-plane deformation area and the maximum out-of-plane displacement of FRP laminates all show an increasing trend along with an increase of a BF content. Optimized BF components can make the energy absorption properties of BF/CF/EP laminates be better than those of pure CF laminates in an impact speed range of 191.64-206.38 m/s.

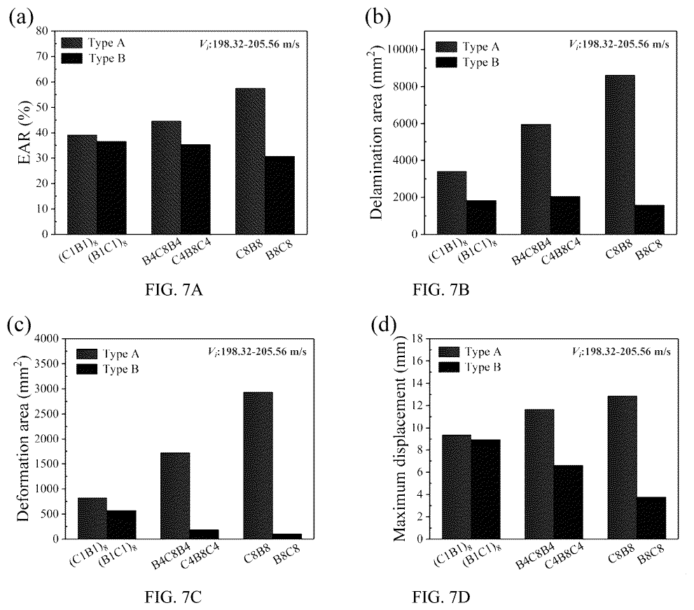

FIGS. 7A-7D show the energy absorption characteristics of FRP composites under different superposing modes (i.e. Example 2). Results show that the superposing mode can significantly affect the energy absorption characteristics of CF/BF/EP composites by changing a failure mechanism of the CF/BF/EP composites. Failure modes of type A samples are mainly delamination failure and tensile failure. Due to sufficient delamination, deformation and displacement, and the energy absorption rate of type A samples is obviously better than that of type B samples, which increases with an increase of the number of BF layers on the backs of the samples.

Obviously, those skilled in the art should understand that the above embodiments of the steps of the present invention can be performed in different ways from the present invention, and the simulation method and experimental apparatuses include but are not limited to the above description. The steps of the present invention described above may in some cases be performed in an order different from that herein, and the steps shown or described above may be performed separately. Therefore, the present invention is not limited to a combination of any specific hardware and software.

The above is a further detailed description of the present invention with reference to the particular embodiments, and it cannot be considered that the particular implementation of the present invention is limited to these descriptions. For those of ordinary skill in the art of the present invention, several simple deductions or substitutions can be made without departing from the spirit of the present invention, which should be regarded as falling within the protection scope of the present invention.

What is claimed is:

1. A manufacturing method for an epoxy resin laminate reinforced by carbon-basalt hybrid fibers, comprising the following steps:
brushing an epoxy resin mixture by using a manual laying method, and laying carbon fiber felts and basalt fiber felts according to components and superposing modes to obtain superposed fiber felts after laying;
placing the superposed fiber felts after laying into a vacuum bag, and evacuating air; and
placing the superposed fiber felts after laying in a vulcanizing machine, heating the superposed fiber felts after laying to a temperature required for a crosslinking reaction between epoxy resin and a curing agent by using a preset heating method, applying a pressure by an upper die and a lower die to make interiors of the superposed fiber felts after laying compact and surfaces of the superposed fiber felts after laying smooth, and keeping the temperature and the pressure to obtain the epoxy resin laminate reinforced by the carbon-basalt hybrid fibers.

2. The manufacturing method for the epoxy resin laminate reinforced by the carbon-basalt hybrid fibers according to claim 1, wherein before using the manual laying method, the manufacturing method further comprises:
cutting the carbon fiber felts and the basalt fiber felts into sizes suitable for a space of a hot pressing.

3. The manufacturing method for the epoxy resin laminate reinforced by the carbon-basalt hybrid fibers according to claim 1, wherein a preparation process of the epoxy resin mixture comprises:
heating the epoxy resin and the curing agent to a liquid state at 75° C. and 100° C. respectively, mixing the epoxy resin in the liquid state and the curing agent in the liquid state at a mass ratio of 100:26.7, and performing electromagnetic stirring under a heating condition of 75° C. to uniformly mix a resulting mixture to obtain the epoxy resin mixture, wherein the epoxy resin is E51 type epoxy resin, and the curing agent is a malonaldehyde (MDA) type curing agent.

4. The manufacturing method for the epoxy resin laminate reinforced by the carbon-basalt hybrid fibers according to claim 1, wherein the step of brushing the epoxy resin mixture comprises:
brushing the epoxy resin mixture over both sides of the carbon fiber felts and both sides of the basalt fiber felts by using a brush, such that the carbon fiber felts and the basalt fiber felts are impregnated with the epoxy resin mixture.

5. The manufacturing method for the epoxy resin laminate reinforced by the carbon-basalt hybrid fibers according to claim 1, wherein the step of laying the carbon fiber felts and the basalt fiber felts according to the components and the superposing modes to obtain the superposed fiber felts after laying comprises:
manually laying 16 layers of superposed fiber felts by changing the components and the superposing modes of the carbon fiber felts and the basalt fiber felts to obtain the superposed fiber felts after laying, wherein
the components of the carbon fiber felts and the basalt fiber felts are as follows:
(1) only the carbon fiber felts are used, and 16 layers of the superposed fiber felts are laid;
(2) a layer number ratio of the carbon fiber felts to the basalt fiber felts is 3:1, a method of laying 1 layer of the basalt fiber felt first and then laying 3 layers of the carbon fiber felts upwards is used, and cycle laying is performed according to the layer number ratio of 3:1 until 16 layers of the superposed fiber felts are laid;
(3) a layer number ratio of the carbon fiber felts to the basalt fiber felts is 1:1, a method of laying 1 layer of the basalt fiber felt first and then laying 1 layer of the carbon fiber felt upwards is used, and cycle laying is performed according to the layer number ratio of 1:1 until 16 layers of the superposed fiber felts are laid;
(4) a layer number ratio of the carbon fiber felts to the basalt fiber felts is 1:3, a method of laying 3 layers of the basalt fiber felts first and then laying 1 layer of the carbon fiber felt upwards is used, and cycle laying is performed according to the layer number ratio of 1:3 until 16 layers of the superposed fiber felts are laid;
(5) only the basalt fiber felts are used, and 16 layers of the superposed fiber felts are laid;
the superposing modes of the carbon fiber felts and the basalt fiber felts comprise:
(1) a method of laying 8 layers of the basalt fiber felts first and then laying 8 layers of the carbon fiber felts upwards is used for laying 16 layers of the superposed fiber felts;
(2) a method of laying 8 layers of the carbon fiber felts first and then laying 8 layers of the basalt fiber felts upwards is used for laying 16 layers of the superposed fiber felts;
(3) a method of laying 4 layers of the carbon fiber felts first, then laying 8 layers of the basalt fiber felts upwards, and finally laying 4 layers of the carbon fiber felts upwards is used for laying 16 layers of the superposed fiber felts;
(4) a method of laying 4 layers of the basalt fiber felts first, then laying 8 layers of the carbon fiber felts upwards, and finally laying 4 layers of the basalt fiber felts upwards is used for laying 16 layers of the superposed fiber felts;
(5) a method of laying 1 layer of the basalt fiber felt first and then laying 1 layer of the carbon fiber felt upwards is used, and cycle laying is performed according to the layer number ratio of the carbon fiber felts to the basalt fiber felts of 1:1 until 16 layers of the superposed fiber felts are laid; and
(6) a method of laying 1 layer of the carbon fiber felt and then laying 1 layer of the basalt fiber felt upwards is used, and cycle laying is performed according to the layer number ratio of the carbon fiber felts to the basalt fiber felts of 1:1 until 16 layers of the superposed fiber felts are laid.

6. The manufacturing method for the epoxy resin laminate reinforced by the carbon-basalt hybrid fibers according to claim 1, wherein the step of placing the superposed fiber felts after laying into the vacuum bag, and evacuating the air comprises:
placing carbon/basalt hybrid fibers after laying in the vacuum bag, laying a polytetrafluoroethylene film between the superposed fiber felts after laying and the vacuum bag for demolding a laminate from the vacuum bag after a hot pressing, and evacuating the air from the vacuum bag at a temperature of 70° C. for degassing, such that the superposed fiber felts after laying are impregnated with the epoxy resin mixture.

7. The manufacturing method for the epoxy resin laminate reinforced by the carbon-basalt hybrid fibers according to claim 1, wherein the step of placing the superposed fiber felts after laying in the vulcanizing machine, heating the superposed fiber felts after laying to the temperature required for the crosslinking reaction between the epoxy resin and the curing agent by using the preset heating method, applying the pressure by the upper die and the lower die to make the interiors of the superposed fiber felts after laying compact and the surfaces of the superposed fiber felts after laying smooth, and keeping the temperature and the pressure to obtain the epoxy resin laminate reinforced by the carbon-basalt hybrid fibers comprises:
placing the superposed fiber felts after laying impregnated with the epoxy resin mixture between heating die plates of the vulcanizing machine, placing a supporting die with a thickness of 3.6 mm between the upper die and the lower die of the vulcanizing machine, and applying the pressure by the upper die and the lower die, such that the interiors of the superposed fiber felts after laying compact, the surfaces of the superposed fiber felts after laying smooth, and the superposed fiber felts after laying have a thickness of 3.6 mm; and performing a hot pressing for 17 h at a constant temperature of 120° C. and a constant pressure, and then performing curing for 2 h after the temperature is 180° C. to obtain the epoxy resin laminate reinforced by the carbon-basalt hybrid fibers.

8. The manufacturing method for the epoxy resin laminate reinforced by the carbon-basalt hybrid fibers according to claim 1, wherein after obtaining the epoxy resin laminate reinforced by the carbon-basalt hybrid fibers, the manufacturing method further comprises:
cutting the epoxy resin laminate reinforced by the carbon-basalt hybrid fibers into a standard size of 105×105 mm² by using a high speed rotating serrated disc.

9. An epoxy resin laminate reinforced by carbon-basalt hybrid fibers, being obtained by using the manufacturing method according to claim 1.

10. The epoxy resin laminate reinforced by the carbon-basalt hybrid fibers according to claim 9, wherein in the manufacturing method, wherein before using the manual laying method, the manufacturing method further comprises:
cutting the carbon fiber felts and the basalt fiber felts into sizes suitable for a space of a hot pressing.

11. The epoxy resin laminate reinforced by the carbon-basalt hybrid fibers according to claim 9, wherein in the manufacturing method, a preparation process of the epoxy resin mixture comprises:
heating the epoxy resin and the curing agent to a liquid state at 75° C. and 100° C. respectively, mixing the epoxy resin in the liquid state and the curing agent in the liquid state at a mass ratio of 100:26.7, and performing electromagnetic stirring under a heating condition of 75° C. to uniformly mix a resulting mixture to obtain the epoxy resin mixture, wherein the epoxy resin is E51 type epoxy resin, and the curing agent is a malonaldehyde (MDA) type curing agent.

12. The epoxy resin laminate reinforced by the carbon-basalt hybrid fibers according to claim 9, wherein in the manufacturing method, the step of brushing the epoxy resin mixture comprises:
brushing the epoxy resin mixture over both sides of the carbon fiber felts and both sides of the basalt fiber felts by using a brush, such that the carbon fiber felts and the basalt fiber felts are impregnated with the epoxy resin mixture.

13. The epoxy resin laminate reinforced by the carbon-basalt hybrid fibers according to claim 9, wherein in the manufacturing method, the step of laying the carbon fiber felts and the basalt fiber felts according to the components and the superposing modes to obtain the superposed fiber felts after laying comprises:
manually laying 16 layers of superposed fiber felts by changing the components and the superposing modes of the carbon fiber felts and the basalt fiber felts to obtain the superposed fiber felts after laying, wherein
the components of the carbon fiber felts and the basalt fiber felts are as follows:
(1) only the carbon fiber felts are used, and 16 layers of the superposed fiber felts are laid;
(2) a layer number ratio of the carbon fiber felts to the basalt fiber felts is 3:1, a method of laying 1 layer of the basalt fiber felt first and then laying 3 layers of the carbon fiber felts upwards is used, and cycle laying is performed according to the layer number ratio of 3:1 until 16 layers of the superposed fiber felts are laid;
(3) a layer number ratio of the carbon fiber felts to the basalt fiber felts is 1:1, a method of laying 1 layer of the basalt fiber felt first and then laying 1 layer of the carbon fiber felt upwards is used, and cycle laying is performed according to the layer number ratio of 1:1 until 16 layers of the superposed fiber felts are laid;
(4) a layer number ratio of the carbon fiber felts to the basalt fiber felts is 1:3, a method of laying 3 layers of the basalt fiber felts first and then laying 1 layer of the carbon fiber felt upwards is used, and cycle laying is performed according to the layer number ratio of 1:3 until 16 layers of the superposed fiber felts are laid;
(5) only the basalt fiber felts are used, and 16 layers of the superposed fiber felts are laid;
the superposing modes of the carbon fiber felts and the basalt fiber felts comprise:
(1) a method of laying 8 layers of the basalt fiber felts first and then laying 8 layers of the carbon fiber felts upwards is used for laying 16 layers of the superposed fiber felts;
(2) a method of laying 8 layers of the carbon fiber felts first and then laying 8 layers of the basalt fiber felts upwards is used for laying 16 layers of the superposed fiber felts;
(3) a method of laying 4 layers of the carbon fiber felts first, then laying 8 layers of the basalt fiber felts upwards, and finally laying 4 layers of the carbon fiber felts upwards is used for laying 16 layers of the superposed fiber felts;
(4) a method of laying 4 layers of the basalt fiber felts first, then laying 8 layers of the carbon fiber felts upwards, and finally laying 4 layers of the basalt fiber felts upwards is used for laying 16 layers of the superposed fiber felts;
(5) a method of laying 1 layer of the basalt fiber felt first and then laying 1 layer of the carbon fiber felt upwards is used, and cycle laying is performed according to the layer number ratio of the carbon fiber felts to the basalt fiber felts of 1:1 until 16 layers of the superposed fiber felts are laid; and
(6) a method of laying 1 layer of the carbon fiber felt and then laying 1 layer of the basalt fiber felt upwards is used, and cycle laying is performed according to the layer number ratio of the carbon fiber felts to the basalt fiber felts of 1:1 until 16 layers of the superposed fiber felts are laid.

14. The epoxy resin laminate reinforced by the carbon-basalt hybrid fibers according to claim 9, wherein in the manufacturing method, the step of placing the superposed fiber felts after laying into the vacuum bag, and evacuating the air comprises:
placing carbon/basalt hybrid fibers after laying in the vacuum bag, laying a polytetrafluoroethylene film between the superposed fiber felts after laying and the vacuum bag for demolding a laminate from the vacuum bag after a hot pressing, and evacuating the air from the vacuum bag at a temperature of 70° C. for degassing, such that the superposed fiber felts after laying are impregnated with the epoxy resin mixture.

15. The epoxy resin laminate reinforced by the carbon-basalt hybrid fibers according to claim 9, wherein in the manufacturing method, the step of placing the superposed fiber felts after laying in the vulcanizing machine, heating the superposed fiber felts after laying to the temperature required for the crosslinking reaction between the epoxy resin and the curing agent by using the preset heating method, applying the pressure by the upper die and the lower die to make the interiors of the superposed fiber felts after laying compact and the surfaces of the superposed fiber felts after laying smooth, and keeping the temperature and the pressure to obtain the epoxy resin laminate reinforced by the carbon-basalt hybrid fibers comprises:
placing the superposed fiber felts after laying impregnated with the epoxy resin mixture between heating die plates of the vulcanizing machine, placing a supporting die with a thickness of 3.6 mm between the upper die and the lower die of the vulcanizing machine, and applying the pressure by the upper die and the lower die, such that the interiors of the superposed fiber felts after laying compact, the surfaces of the superposed fiber felts after laying smooth, and the superposed fiber felts after laying have a thickness of 3.6 mm; and performing a hot pressing for 17 h, a constant temperature of 120° C. and a constant pressure, and then performing curing for 2 h after the temperature is 180° C. to obtain the epoxy resin laminate reinforced by the carbon-basalt hybrid fibers.

16. The epoxy resin laminate reinforced by the carbon-basalt hybrid fibers according to claim 9, wherein in the manufacturing method, after obtaining the epoxy resin laminate reinforced by the carbon-basalt hybrid fibers, the manufacturing method further comprises:
cutting the epoxy resin laminate reinforced by the carbon-basalt hybrid fibers into a standard size of 105×105 mm² by using a high speed rotating serrated disc.
